(19) United States
(12) Patent Application Publication
(10) Pub. No.: US 2022/0001653 A1
(43) Pub. Date: Jan. 6, 2022

(54) COVERS FOR ELECTRONIC DEVICES

(71) Applicant: Hewlett-Packard Development Company, L.P., Spring, TX (US)

(72) Inventors: Kuan-Ting Wu, Taipei (TW); Shing-Hung Hsieh, Taipei (TW); Super Liao, Taipei (TW)

(73) Assignee: Hewlett-Packard Development Company, L.P., Spring, TX (US)

(21) Appl. No.: 17/054,570

(22) PCT Filed: Mar. 22, 2019
(86) PCT No.: PCT/US2019/023507

§ 371 Date: Nov. 11, 2020

(51) Int. Cl. B32B 27/08; B32B 27/30; B32B 27/36; B32B 27/32; B32B 27/20; B32B 25/20; B32B 25/08; B32B 7/12; B32B 17/06; B32B 5/02; B32B 27/12; B32B 37/16; B32B 15/082; B32B 15/09; B32B 15/085; B32B 7/023; C09D 133/12; C09D 7/41; G06F 1/16

(52) U.S. Cl. CPC B32B 27/08; B32B 2270/00; B32B 27/365; B32B 27/325; B32B 27/20; B32B 27/36; B32B 27/304; B32B 25/20; B32B 25/08; B32B 7/12; B32B 17/06; B32B 5/02; B32B 27/12; B32B 37/16; B32B 15/082; B32B 15/09; B32B 15/085; B32B 7/023; C09D 133/12; C09D 7/41; G06F 1/1656; B32B 2307/418; B32B 2307/41; B32B 2264/10; B32B 2307/4026; B32B 2264/1023; B32B 2264/1051; B32B 2307/412; B32B 2262/106; B32B 2457/00; B32B 2250/03; B32B 2264/12; B32B 27/308

(57) ABSTRACT

The present disclosure describes covers for electronic devices, electronic devices, and methods of making covers for the electronic devices. In an example, a cover for an electronic device can comprise: a rigid substrate; a high refraction polymeric film adherable on the rigid substrate; a semitransparent polymeric film adherable on the high refraction polymeric film, wherein the high refraction polymeric film comprises: polyacrylic, polycarbonate, cyclic olefin copolymer, or combinations thereof, and high refractive nanoparticles, and wherein the semi-transparent polymeric film comprises: polyester, polyacrylic, polycarbonate, polyvinyl chloride, silicone rubber, or combinations thereof, and at least one colorant.

### BACKGROUND

The use of personal electronic devices of all types continues to increase. Cellular phones, including smartphones, have become nearly ubiquitous. Tablet computers have also become widely used in recent years. Portable laptop computers continue to be used by many for personal, entertainment, and business purposes. For portable electronic devices in particular, much effort has been expended to make these devices more useful and more powerful while at the same time making the devices smaller, lighter, and more durable. The aesthetic design of personal electronic devices is also of concern in this competitive market.

### BRIEF DESCRIPTION OF THE DRAWING

FIG. 1 is a cross-sectional view illustrating an example cover for an electronic device in accordance with examples of the present disclosure;

FIG. 2 is a cross-sectional view illustrating another example cover for an electronic device in accordance with examples of the present disclosure;

FIG. 3 is a flow chart showing an example of a method of forming a cover for an electronic device in accordance with examples of the present disclosure; and

FIG. 4 is a flow chart showing an example of a method of forming a cover for an electronic device in accordance with examples of the present disclosure.

### DETAILED DESCRIPTION

The present disclosure describes covers for electronic devices, electronic devices, and methods of making covers for electronic devices. In some examples, described herein is a cover for an electronic device comprising: a rigid substrate; a high refraction polymeric film adherable on the rigid substrate; a semi-transparent polymeric film adherable on the high refraction polymeric film, wherein the high refraction polymeric film comprises: polyacrylic, polycarbonate, cyclic olefin copolymer, or combinations thereof, and high refractive nanoparticles, and wherein the semi-transparent polymeric film comprises: polyester, polyacrylic, polycarbonate, polyvinyl chloride, silicone rubber, or combinations thereof, and at least one colorant.

In some examples, the high refractive nanoparticles comprise hematite, proustite, cuprite, crocoite, zirconia, tantalite, wulfenite, sphalerite, phosgenite, chromite, cassiterite, or mixtures thereof.

In some examples, the high refractive nanoparticles have a refractive index of from about 2.0 to about 3.2.

In some examples, the high refractive nanoparticles are present in the high refraction polymeric film in an amount of from about 0.01 wt % to about 0.3 wt % based on the total weight of the high refraction polymeric film.

In some examples, the high refraction polymeric film has a glass transition temperature of from about 80° C. to about 180° C.

In some examples, the polyacrylic is polymethylmethacrylate.

In some examples, the at least one colorant comprises dyes, metal powder, pearlescent pigments, pigments, or combinations thereof.

In some examples, the colorant is present in the semi-transparent polymeric film in an amount of from about 0.01 wt % to 0.5 wt % based on the total weight of the semi-transparent polymeric film.

In some examples, the metal powder comprises mica powder, mica flakes, alumina powder, alumina flakes, silver particles, or combinations thereof.

In some examples, the semi-transparent polymeric film has a refractive index of from about 1.3 to about 1.6.

In some examples, the cover further comprising an optically transparent adhesive layer on a bottom surface of the high refraction polymeric film, wherein the optically transparent adhesive layer comprises epoxy, polyurethane acrylate, polyacrylic, silicone, cyanoacrylate, or combinations thereof.

In some examples, the cover further comprising an adhesive layer on a top surface of the high refraction polymeric film, wherein the adhesive layer comprises epoxy, polyurethane acrylate, polyacrylic, silicone, cyanoacrylate, or combinations thereof.

In some examples, the rigid substrate comprises metal, carbon fiber, glass, plastic, metal/plastic, carbon fiber/metal, metal/glass, carbon fiber/glass, or combinations thereof.

In some examples, an electronic device comprises the cover described above.

In some examples, disclosed herein is a method of making a cover for an electronic device, the method comprising: applying a high refraction polymeric film on a rigid substrate, wherein the high refraction polymeric film comprises: polyacrylic, polycarbonate, cyclic olefin copolymer, or combinations thereof, and high refractive nanoparticles; and applying a semi-transparent polymeric film on the high refraction polymeric film, wherein the semi-transparent polymeric film comprises: polyester, polyacrylic, polycarbonate, polyvinyl chloride, silicone rubber, or combinations thereof, and at least one colorant.

In some examples, one or more layers of high refraction polymeric film and semi-transparent polymeric film are adhered to a rigid substrate. In some examples, these films can be designed to have a color, sparkling, or metallic appearance.

In various examples, the high refraction polymeric film comprises: polyacrylic, polycarbonate, cyclic olefin copolymer, or combinations thereof, and high refractive nanoparticles. In various examples, the semi-transparent polymeric film comprises: polyester, polyacrylic, polycarbonate, polyvinyl chloride, silicone rubber, or combinations thereof, and at least one colorant.

In some examples, the high refractive nanoparticles comprise hematite, proustite, cuprite, crocoite, zirconia, tantalite, wulfenite, sphalerite, phosgenite, chromite, cassiterite, or mixtures thereof. The high refractive nanoparticles have a refractive index of from about 2.0 to about 3.2, or from about 2.1 to about 3.1, or from about 2.2 to about 3.0, or from about 2.3 to about 2.9, or from about 2.4 to about 2.8, or less than about 3.2. The high refractive nanoparticles are present in the high refraction polymeric film in an amount of from about 0.01 wt % to about 0.3 wt % based on the total weight of the high refraction polymeric film, or from about 0.05 wt % to about 0.2 wt %, or less than about 0.5 wt %, or less than about 0.4 wt %. The balance of the high refraction polymeric film comprises polyacrylic, polycarbonate, cyclic olefin copolymer, or combinations thereof. It is to be understood that the high refraction polymeric film can comprise fillers and/or stabilizers in amounts less than about 1 wt % based on the total weight of the high refraction polymeric film.

In some examples, the high refraction polymeric film has a glass transition temperature of from about 80° C. to about 180° C., or less than about 200° C., or less than about 190° C., or less than about 180° C., or less than about 170° C., or less than about 160° C., or less than about 150° C., or less than about 140° C., or less than about 130° C., or less than about 120° C., or less than about 110° C., or less than about 100° C., or less than about 90° C., or at least about 75° C., or at least about 85° C., or at least about 95° C., or at least about 105° C., or at least about 115° C., or at least about 125° C., or at least about 135° C., or at least about 145° C., or at least about 155° C., or at least about 165° C.

In some examples, the polyacrylic is polymethylmethacrylate.

In some examples, the at least one colorant comprises dyes, metal powder, pearlescent pigments, pigments, or combinations thereof.

In some examples, the dyes can refer to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description describes the use of pigment colorants, the term “pigment” can be used more generally to describe pigment colorants and other pigments such as organometallics, ferrites, ceramics, etc. In one specific example, however, the pigment is a pigment colorant

Non-limiting examples of colorant includes carbon black, titanium dioxide, clay, mica, talc, barium sulfate, calcium carbonate, synthetic pigment, metallic powder, aluminum oxide, graphene, pearl pigment, or a combination thereof.

In some examples, the colorant is present in the semi-transparent polymeric film in an amount of from about 0.01 wt % to 0.5 wt % based on the total weight of the semi-transparent polymeric film, or from about 0.02 wt % to about 0.4 wt %, or from about 0.03 wt % to about 0.3 wt %, or from 0.04 wt % to about 0.4 wt %, or from about 0.05 wt % to about 0.5 wt %. The balance of the semi-transparent polymeric film comprises polyacrylic, polycarbonate, cyclic olefin copolymer, or combinations thereof. It is to be understood that the semi-transparent polymeric film can comprise fillers and/or stabilizers in amounts less than about 1 wt % based on the total weight of the semi-transparent polymeric film.

In some examples, the metal powder comprises mica powder, mica flakes, alumina powder, alumina flakes, silver particles, or combinations thereof.

In some examples, the semi-transparent polymeric film has a refractive index of from about 1.3 to about 1.6, or less than about 2.0, or less than about 1.9, or less than about 1.8, or less than about 1.7, or less than about 1.6, or at least about 1.0, or at least about 1.1, or at least about 1.2, or at least about 1.3, or at least about 1.4, or at least about 1.5.

In some examples, the rigid substrate comprises metal, carbon fiber, glass, plastic, metal/plastic, carbon fiber/metal, metal/glass, carbon fiber/glass, or combinations thereof.

In further examples, the high refraction polymeric film and semi-transparent polymeric film forming the cover can provide a desired appearance to the cover for an electronic device without interfering with radio wave transmission to or from the electronic device. Many electronic devices include transceivers for sending and receiving radio waves to cellular networks, Wi-Fi routers, wireless accessories, and so on. Some materials can block or interfere with these radio waves. In particular, metal enclosures can often block incoming and outgoing radio waves. The high refraction polymeric film and semi-transparent polymeric film described herein can provide a desired appearance, including a metallic appearance, without blocking radio waves.

The high refraction polymeric film and semi-transparent polymeric film described herein can be produced by efficient manufacturing processes such as roll-to-roll process, out molding process, or combinations thereof. In certain examples, a roll-to-roll process can be used to add the various layers of materials to the cover.

As used herein, “cover” refers to the exterior shell or housing of an electronic device. In other words, the cover contains the internal electronic components of the electronic device. The cover is an integral part of the electronic device. The high refraction polymeric film and semi-transparent polymeric film described here are adherable to a cover of electronic devices, but in some examples, they are actually adhered to the cover of the electronic device. The term “cover” is not meant to refer to the type of removable protective cases that are often purchased separately from an electronic device (especially smartphones and tablets) and placed around the exterior of the electronic device. However, the high refraction polymeric film and semi-transparent polymeric film described herein may be adhered to other surfaces besides covers for electronic devices, e.g., to removable protective cases or other surfaces.

FIG. 1 shows a cross-sectional view of an example cover 100 for an electronic device accordance with an example of the present disclosure. The cover can include a rigid substrate 106, a high refraction polymeric film 104 adherable on the rigid substrate 106, and a semi-transparent polymeric film 102 adherable on the high refraction polymeric film 104.

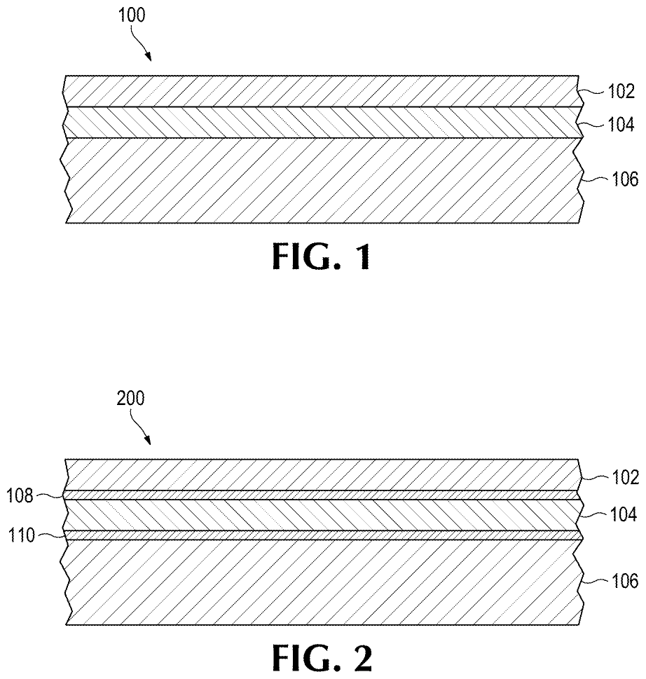

FIG. 2 shows a cross-sectional view of another example cover 200 for an electronic device accordance with another example of the present disclosure. The cover can include a rigid substrate 106, a high refraction polymeric film 104, and a semi-transparent polymeric film 102. The cover can further include an optically transparent adhesive layer 110 on a bottom surface of the high refraction polymeric film 104, wherein the optically transparent adhesive layer comprises epoxy, polyurethane acrylate, polyacrylic, silicone, cyanoacrylate, or combinations thereof. The cover can further include another adhesive layer 108 on a top surface of the high refraction polymeric film 104, wherein the adhesive layer comprises epoxy, polyurethane acrylate, polyacrylic, silicone, cyanoacrylate, or combinations thereof.

It is noted that when discussing covers for electronic devices or methods of making covers for electronic devices, such discussions can be considered applicable to one another whether or not they are explicitly discussed in the context of that example. It is also understood that terms used herein will take on their ordinary meaning in the relevant technical field unless specified otherwise. In some instances, there are terms defined more specifically throughout or included at the end of the present disclosure, and thus, these terms are supplemented as having a meaning described herein.

In further detail, it is noted that the spatial relationship between layers is often described herein as positioned or applied “on” or “over” another layer. These terms do not infer that this layer is positioned directly in contact with the layer to which it refers, but could have intervening layers therebetween. That being stated, a layer described as being positioned on or over another layer can be positioned directly on that other layer, and thus such a description finds support herein for being positioned directly on the referenced layer.

In some examples, the rigid substrate comprises metal, carbon fiber, glass, plastic, metal/plastic, carbon fiber/metal, metal/glass, carbon fiber/glass, or combinations thereof.

In some examples, the rigid substrate of the cover for an electronic device can include plastic, carbon fiber, glass, metal, a composite, or a combination thereof. In certain examples, the substrate can include a light metal such as aluminum, magnesium, titanium, lithium, niobium, or an alloy thereof. In some examples, alloys of these metals can include additional metals, such as bismuth, copper, cadmium, iron, thorium, strontium, zirconium, manganese, nickel, lead, silver, chromium, silicon, tin, gadolinium, yttrium, calcium, antimony, zinc, cerium, lanthanum, or others. In a particular example, the substrate can be pure magnesium or an alloy including 99% magnesium or greater. In another particular example, the substrate can be made of an alloy including magnesium and aluminum. In a particular example, the substrate can be made from AZ31 alloy or AZ91 alloy.

In further examples, the substrate can include carbon fiber. In particular, the substrate can be a carbon fiber composite. The carbon fiber composite can include carbon fibers in a plastic material such as a thermoset resin or a thermoplastic polymer. Non-limiting examples of the polymer can include epoxies, polyesters, vinyl esters, and polyamides.

In various examples, the substrate can be formed by molding, casting, machining, bending, working, or another process. In certain examples, the substrate can be a chassis for an electronic device that is milled from a single block of metal or metal alloy. In other examples, an electronic device chassis can be made from multiple panels. As an example, laptops sometimes include four separate pieces forming the chassis or cover of the laptop, with the electronic components of the laptop protected inside the chassis. The four separate pieces of the laptop chassis are often designated as cover A (back cover of the monitor portion of the laptop), cover B (front cover of the monitor portion), cover C (top cover of the keyboard portion) and cover D (bottom cover of the keyboard portion). In certain examples, one of these covers or more than one of these covers can include metal, metal alloy, carbon fiber, glass, plastic, and so on. These covers can be made by machining, casting, molding, bending, or by other forming methods. Other types of electronic device covers can also be the substrate referred to above, such as a smartphone, tablet, or television cover. These substrates can be made using the same forming methods.

The substrate is not particularly limited with respect to thickness. However, when used as a panel for an electronic device, such as for a housing or chassis, the thickness of the substrate chosen, the density of the material (for purposes of controlling weight, for example), the hardness of the material, the malleability of the material, the material aesthetic, etc., can be selected as appropriate for a specific type of electronics device, e.g., lightweight materials and thickness chosen for housings where lightweight properties may be commercially competitive, heavier more durable materials chosen for housings where more protection may be useful, etc. To provide some examples, the thickness of the substrate can be from about 0.5 mm to about 2 cm, from about 1 mm to about 1.5 cm, from about 1.5 mm to about 1.5 cm, from about 2 mm to about 1 cm, from about 3 mm to about 1 cm, from about 4 mm to about 1 cm, or from about 1 mm to about 5 mm, though thicknesses outside of these ranges can be used.

In some examples, the high refraction polymeric film, the semi-transparent polymeric film, the first adhesive layer or the optically transparent adhesive layer, and the adhesive layer each have thicknesses ranging from about 3 μm to about 30 μm, or from about 5 μm to about 25 μm, or from about 5 μm to about 20 μm, or from about 5 μm to about 15 μm, or less than about 15 μm, or less than about 10 μm, or less than about 8 μm, or less than about 5 μm, or less than about 3 μm, or less than about 2.5 μm, or less than about 1 μm.

The high refraction polymeric film comprises polyacrylic, polycarbonate, cyclic olefin copolymer, or combinations thereof. These polymers can have average particle sizes of from about 10 μm to 1000 μm, or from about 50 μm to about 800 μm, or from about 100 μm to about 500 μm, or less than about 1000 μm, or less than about 800 μm, or less than about 600 μm, or less than about 400 μm, or less than about 200 μm. The high refractive nanoparticles in the high refraction polymeric film can have average particle sizes of less than about 1000 nm, or less than about 500 nm, or less than about 100 nm, or less than about 50 nm, or less than about 20 nm, or less than about 10 nm, or less than about 1 nm.

The semi-transparent polymeric film comprises polyester, polyacrylic, polycarbonate, polyvinyl chloride, silicone rubber, or combinations thereof. These polymers can have average particle sizes of from about 10 μm to 1000 μm, or from about 50 μm to about 800 μm, or from about 100 μm to about 500 μm, or less than about 1000 μm, or less than about 800 μm, or less than about 600 μm, or less than about 400 μm, or less than about 200 μm. The colorant in the semi-transparent polymeric film can have average particle sizes of less than about 1000 nm, or less than about 500 nm, or less than about 100 nm, or less than about 50 nm, or less than about 20 nm, or less than about 10 nm.

In further examples, a rigid substrate may include more than one type of material. In certain examples, a substrate can include a plastic portion formed by insert molding. For example, a substrate can have a metal portion or a carbon fiber portion or a glass portion and an insert molded plastic portion. Insert molding involves placing the substrate portion into a mold, where a plastic material is then injection molded in the mold around the metal, carbon fiber, or glass. In some cases, the metal, carbon fiber, or glass substrate can include an undercut shape and the molten plastic can flow into the undercut during injection molding. When the plastic hardens, the undercut can provide a strong connection between the plastic and the other portion of the substrate.

In still further examples, the rigid substrate can include a metal having a micro-arc oxidation layer on a surface thereof. Micro-arc oxidation, also known as plasma electrolytic oxidation, is an electrochemical process where the surface of a metal is oxidized using micro-discharges of compounds on the surface of the substrate when immersed in a chemical or electrolytic bath, for example. The electrolytic bath may include predominantly water with about 1 wt % to about 5 wt % electrolytic compound(s), e.g., alkali metal silicates, alkali metal hydroxide, alkali metal fluorides, alkali metal phosphates, alkali metal aluminates, the like, and combinations thereof. The electrolytic compounds may likewise be included at from about 1.5 wt % to about 3.5 wt %. or from about 2 wt % to about 3 wt %, though these ranges are not considered limiting. In one example, a high-voltage alternating current can be applied to the substrate to create plasma on the surface of the substrate. In this process, the substrate can act as one electrode immersed in the electrolyte solution, and the counter electrode can be any other electrode that is also in contact with the electrolyte. In some examples, the counter electrode can be an inert metal such as stainless steel. In certain examples, the bath holding the electrolyte solution can be conductive and the bath itself can be used as the counter electrode. A high direct current or alternating voltage can be applied to the substrate and the counter electrode. In some examples, the voltage can be 200 V or higher, such as about 200 V to about 600 V, about 250 V to about 600 V, about 250 V to about 500 V, or about 200 V to about 300 V. Temperatures can be from about 20° C. to about 40° C., or from about 25° C. to about 35° C., for example, though temperatures outside of these ranges can be used. This process can oxidize the surface to form an oxide layer from the substrate material. Various metal or metal alloy substrates can be used, including aluminium, titanium, lithium, magnesium, and/or alloys thereof, for example. The oxidation can extend below the surface to form thick layers, as thick as 30 μm or more. In some examples the oxide layer can have a thickness from about 1 μm to about 25 μm, from about 1 μm to about 22 μm, or from about 2 μm to about 20 μm. Thickness can likewise be from about 2 μm to about 15 μm, from about 3 μm to about 10 μm, or from about 4 μm to about 7 μm. The oxide layer can, in some instances, enhance the mechanical, wear, thermal, dielectric, and corrosion properties of the substrate. The electrolyte solution can include a variety of electrolytes, such as a solution of potassium hydroxide. In some examples, the rigid substrate can include a micro-arc oxidation layer on one side, or on both sides.

In some examples, a high refraction polymeric film as described above can be adhered directly to a rigid substrate with or without an optically transparent adhesive layer.

The optically transparent adhesive layer can increase adhesion of the high refraction polymeric film to the substrate. In a particular example, the optically transparent adhesive layer can be applied over a micro-arc oxidation layer on a metal substrate to increase the adhesion between the high refraction polymeric film and the micro-arc oxidation layer. In another example, an optically transparent adhesive layer can be applied over a rigid substrate that includes a metal portion and an insert molded plastic portion. The optically transparent adhesive layer can increase adhesion and also fill in any gaps or uneven surfaces at the junction between the metal and the plastic. In some examples, the optically transparent adhesive layer can include epoxy, polyurethane acrylate, polyacrylic, silicone, cyanoacrylate, or combinations thereof.

The next optional adhesive layer and the semi-transparent polymeric film can then be deposited using lamination techniques.

In various examples, a three dimensional pattern can be molded into a top surface of the semi-transparent polymeric film, which can contribute to a decorative appearance and/or provide a particular tactile texture to be felt by a user. In some examples, the three dimensional pattern can be designed to contribute to a sparkling or metallic appearance of the semi-transparent polymeric film. In certain examples, the three dimensional pattern can include multiple small facets that are angled at different orientations to reflect light in different directions, similar to facets of a cut gemstone. Incident light can be reflected and refracted by these facets in such a way that the film can have a sparkling appearance due to the three dimensional molded pattern of the top semi-transparent polymeric film layer. This sparkling effect can in some cases be in addition to the sparkling appearance provided by the high refraction polymeric film and/or the semi-transparent polymeric film. A wide variety of designs can be used for the three dimensional molded pattern. The three dimensional pattern can be designed to provide a sparkling appearance, an appearance similar to brushed metal, an appearance of a color gradient, and others.

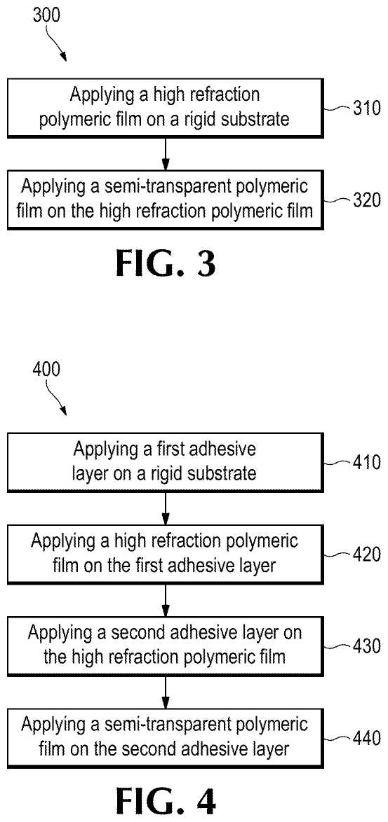

The present disclosure also extends to methods of making covers for electronic devices. FIG. 3 is a flowchart showing an example method 300 of making a cover for an electronic device. The method includes: applying a high refraction polymeric film on a rigid substrate (310) and applying a semi-transparent polymeric film on the high refraction polymeric film (320).

The present disclosure also extends to methods of making covers for electronic devices. FIG. 4 is a flowchart showing an example method 400 of making a cover for an electronic device. The method includes: applying a first adhesive layer on a rigid substrate (410); applying a high refraction polymeric film on the first adhesive layer (420); applying a second adhesive layer on the high refraction polymeric film (430); and applying a semi-transparent polymeric film on the second adhesive layer (440).

The first adhesive layer is the optically transparent adhesive layer. The optically transparent adhesive layer is applied on a bottom surface of the high refraction polymeric film. This optically transparent adhesive layer comprises epoxy, polyurethane acrylate, polyacrylic, silicone, cyanoacrylate, or combinations thereof.

The second adhesive layer on a top surface of the high refraction polymeric film and this second adhesive layer comprises epoxy, polyurethane acrylate, polyacrylic, silicone, cyanoacrylate, or combinations thereof.

In some examples, the semi-transparent polymeric film can include a radiation-curable resin. As such, in some examples the method of making the semi-transparent polymeric film can include applying radiation energy to the semi-transparent polymeric film to cure the radiation-curable resin. In certain examples, the semi-transparent polymeric film can include a UV-curable poly(meth)acrylic, polyurethane, urethane (meth)acrylate, (meth)acrylic (meth)acrylate, or epoxy (meth)acrylate. In further examples, the semi-transparent polymeric film can be cured by applying UV radiation. Curing can include exposing the layer to radiation energy at an intensity from about 500 mJ/cm² to about 2,000 mJ/cm² or from about 700 mJ/cm² to about 1,300 mJ/cm². The layer can be exposed to the radiation energy for a curing time from about 5 seconds to about 30 seconds, or from about 10 seconds to about 30 seconds. In other examples, curing can include heating the protective coating layer at a temperature from about 50° C. to about 80° C. or from about 50° C. to about 60° C. or from about 60° C. to about 80° C. The layer can be heated for a curing time from about 5 minutes to about 40 minutes, or from about 5 minutes to about 10 minutes, or from about 20 minutes to about 40 minutes.

In further examples, the methods of making covers for electronic devices can be continuous methods, such as roll-to-roll methods. In one such example, a roller of a high refraction polymeric film and/or a semi-transparent polymeric film can be fed from roll through equipment suitable to add these layers and optionally the adhesive layers to the rigid substrate. In such a roll-to-roll process, a three dimensional pattern of the semi-transparent polymeric film can be formed by pressing a three dimensional pattern roller onto the semi-transparent polymeric film. In some examples, this can be done prior to curing the semi-transparent polymeric film.

In other examples, the three dimensional pattern can be formed by out molding. “Out molding” as used herein refers to a process in which a semi-transparent polymeric film, such as a sheet, is placed in a stationary mold to mold the three dimensional pattern. Thus, this is more of a batch process than a continuous process as a single sheet is molded at one time.

A wide variety of different three dimensional patterns can be molded into the semi-transparent polymeric film. In some examples, the three dimensional patterns can contribute to the sparkling or metallic appearance of the film. In further examples, the three dimensional pattern can give the film a specific tactile texture to be felt by the user. In certain examples, the three dimensional pattern can mimic the texture of another material, such as leather, wood, stone, and so on.

In some examples, the three dimensional pattern can include multiple facets of the surface that are oriented at different angles. Because of the reflection and refraction of light by the semi-transparent polymeric film, the facets may reflect different amounts of light depending on the angle of incident light. The light reflected by the facets can therefore change when the incident angle of light is changed, either by tilting the film or moving the light source. In some cases, this can result in a sparkling appearance.

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a layer thickness from about 0.1 μm to about 0.5 μm should be interpreted to include the explicitly recited limits of 0.1 μm to 0.5 μm, and to include thicknesses such as about 0.1 μm and about 0.5 μm, as well as subranges such as about 0.2 μm to about 0.4 μm, about 0.2 μm to about 0.5 μm, about 0.1 μm to about 0.4 μm etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

What is claimed is:

1. A cover for an electronic device comprising:
a rigid substrate;
a high refraction polymeric film adherable on the rigid substrate; and
a semi-transparent polymeric film adherable on the high refraction polymeric film,
wherein the high refraction polymeric film comprises:
polyacrylic, polycarbonate, cyclic olefin copolymer, or
combinations thereof, and
high refractive nanoparticles, and
wherein the semi-transparent polymeric film comprises:
polyester, polyacrylic, polycarbonate, polyvinyl chloride, silicone rubber, or combinations thereof, and
at least one colorant.

2. The cover of claim 1, wherein the high refractive nanoparticles comprise hematite, proustite, cuprite, crocoite, zirconia, tantalite, wulfenite, sphalerite, phosgenite, chromite, cassiterite, or mixtures thereof.

3. The cover of claim 1, wherein the high refractive nanoparticles have a refractive index of from about 2.0 to about 3.2.

4. The cover of claim 1, wherein the high refractive nanoparticles are present in the high refraction polymeric film in an amount of from about 0.01 wt % to about 0.3 wt % based on the total weight of the high refraction polymeric film.

5. The cover of claim 1, wherein the high refraction polymeric film has a glass transition temperature of from about 80° C. to about 180° C.

6. The cover of claim 1, wherein the polyacrylic is polymethylmethacrylate.

7. The cover of claim 1, wherein the at least one colorant comprises dyes, metal powder, pearlescent pigments, pigments, or combinations thereof.

8. The cover of claim 1, wherein the colorant is present in the semi-transparent polymeric film in an amount of from about 0.01 wt % to 0.5 wt % based on the total weight of the semi-transparent polymeric film.

9. The cover of claim 1, wherein the metal powder comprises mica powder, mica flakes, alumina powder, alumina flakes, silver particles, or combinations thereof.

10. The cover of claim 1, wherein the semi-transparent polymeric film has a refractive index of from about 1.3 to about 1.6.

11. The cover of claim 1, further comprising an optically transparent adhesive layer on a bottom surface of the high refraction polymeric film, wherein the optically transparent adhesive layer comprises epoxy, polyurethane acrylate, polyacrylic, silicone, cyanoacrylate, or combinations thereof.

12. The cover of claim 1, further comprising an adhesive layer on a top surface of the high refraction polymeric film, wherein the adhesive layer comprises epoxy, polyurethane acrylate, polyacrylic, silicone, cyanoacrylate, or combinations thereof.

13. The cover of claim 1, wherein the rigid substrate comprises metal, carbon fiber, glass, plastic, metal/plastic, carbon fiber/metal, metal/glass, carbon fiber/glass, or combinations thereof.

14. An electronic device comprising the cover of claim 1.

15. A method of making a cover for an electronic device, the method comprising:
applying a high refraction polymeric film on a rigid substrate, wherein the high refraction polymeric film comprises: polyacrylic, polycarbonate, cyclic olefin copolymer, or combinations thereof, and high refractive nanoparticles; and
applying a semi-transparent polymeric film on the high refraction polymeric film, wherein the semi-transparent polymeric film comprises: polyester, polyacrylic, polycarbonate, polyvinyl chloride, silicone rubber, or combinations thereof, and at least one colorant.
